(19) United States
(12) Patent Application Publication
(10) Pub. No.: US 2009/0008227 A1
(43) Pub. Date: Jan. 8, 2009

(54) Motion switch

(76) Inventor: Norishige Yamaguchi, Chiba-shi (JP)

Correspondence Address: BRUCE L. ADAMS, ESQ;ADAMS & WILKS, SUITE 1231, 17 BATTERY PLACE, New York, NY, 10004, US

(21) Appl. No.: 12/215,169

(22) Filed: Jun. 25, 2008

(30) Foreign Application Priority Data
Jul. 4, 2007 (JP) 2007-176231

(51) Int. Cl. H01H 35/14

(52) U.S. Cl. 200/61.53

(57) ABSTRACT

An ultracompact, highly reliable mechanical type motion switch is provided which can be used for long periods of time even in severe environments such as in a high-temperature state. A motion switch has a bottomed cylindrical metallic case and a lower cover which is pressed fitted and secured in the metallic case. Two leads are penetratingly provided in the lower cover, each lead being supported and fixed in the lower cover and electrically insulated from the lower cover by a hermetic seal. Each lead extends from the lower cover toward a side of an innermost wall up to a predetermined position spaced apart from the innermost wall. A metallic ball is disposed between the innermost wall and each detecting end at a distal end of each lead so as to be movable therebetween. A coil spring having a proximal end secured to the lower cover is disposed inside the metallic case so as to surround the two leads. A distal end portion of the coil spring resiliently presses the metallic ball toward the inner wall side by its resilient force.

### BACKGROUND OF THE INVENTION

1. Field of the Invention

The present invention relates to a mechanical type ultracompact motion switch.

2. Description of the Related Art

In recent years, coupled with the increasingly widespread use of automotive vehicles and technologies concerning the miniaturization and sophistication of electronic devices, high-performance computerization, such as vehicle driving support systems including the anti-lock brake system (ABS) and the skid prevention system, is rapidly underway. Amidst these trends, the power saving of these electronic devices for automotive vehicles has become increasingly important. For this reason, there has also been an increasing demand for the miniaturization and high performance of motion switches for starting electronic devices from the start of movement of the vehicle. Conventionally, an electrodynamic type, a strain gauge type, a piezoelectric type, a piezoresistance type, an electrostatic capacity type, a heat detection type, and the like have been devised as the motion switches. As compact types among them, it is possible to cite the piezoresistance type, the electrostatic capacitance type, and the heat detection type. Further, semiconductor acceleration sensors in which the effect due to the temperature change is small, for example, have also been proposed. A three-axis acceleration sensor is included among them and is called a micro electro mechanical system (MEMS) since an acceleration detection mechanism is fabricated by a semiconductor process.

Meanwhile, mechanical-type motion switches having various mechanisms have also long been devised, and some of them are adopted as motion switches for electronic devices for automotive vehicles. Further, compact and easy-to-manufacture acceleration switches, for example, have been proposed. This compact acceleration switch includes a metallic container, an inertial ball disposed in the metallic container and having a smaller diameter than the inside diameter of the metallic container, and a movable contact which is disposed between the metallic container and the inertial ball, has a resilient force for holding the inertial ball in spaced-apart relation to the inner surfaces of the metallic container, and is not brought into contact with the inner surfaces of the metallic container. Then, when an acceleration of a predetermined magnitude or greater is applied to the inertial ball, the inertial ball presses the movable contact by inertia to bring the movable contact into contact with the metallic container and allow the movable contact and the metallic container to conduct with each other, thereby detecting the acceleration.

Incidentally, in terms of the reliability in a severe environment such as a high-temperature state as in the vicinity of a vehicle engine or inside a tire, these MEMSes such as the semiconductor acceleration sensors have had the problem of undergoing a malfunction upon receiving the effect of heat and the like since the motion detection mechanism is formed by a semiconductor, as described above. In addition, the MEMSes have had problems in that, in comparison with the purely mechanical type, there is a limit to the simplification of their structures since the detection mechanism is formed by a semiconductor, and that, in order to attain an ultracompact size, high-precision, expensive semiconductor manufacturing equipment is required correspondingly.

In addition, although mechanical type motion switches having various mechanisms have long been devised, the present situation is such that mechanisms which can be made more compact than MEMSes in terms of the size have practically not been devised. Further, conventional acceleration switches have had a problem in that the adjustment of the resilient force of the movable contact is not easy.

### SUMMARY OF THE INVENTION

The present invention has been devised to overcome the above-described problems, and its object is to provide an ultracompact, highly reliable mechanical type motion switch which can be used for long periods of time even in severe environments such as in a high-temperature state.

In accordance with a first aspect of the invention, there is provided a motion switch comprising: a bottomed cylindrical metallic case; a lower cover for sealing an opening of the case; a metallic lead penetrating the lower cover and fixed therein; an electrically conductive weight disposed in a hermetically sealed space of the case sealed by the lower cover in such a manner as to be movable between an innermost wall of the case and a distal end portion of the lead; and a spring for resiliently pressing the weight disposed in the hermetically sealed space in a predetermined direction toward one of the innermost wall of the case and the distal end portion of the lead.

In accordance with a second aspect of the invention, two leads are provided as the lead in such a manner as to penetrate the lower cover and to be fixed therein.

In accordance with a third aspect of the invention, the lower cover comprises a metallic ring fitted to the case and a glass filled in the metallic ring, and the spring is wound around an outer side of the lead projecting into the hermetically sealed space so as to resiliently press the weight toward a side of the innermost wall of the case.

In accordance with a fourth aspect of the invention, a material of the spring is preferably an elastic material having properties in which a modulus of longitudinal elasticity is 206 to 225 gigapascals and a modulus of transverse elasticity is 80.4 to 83.3 gigapascals.

In accordance with a fifth aspect of the invention, a material of the spring more preferably has a composition comprising by weight at least 0.05% or less C, 15 to 18% Ni, 10 to 14% Cr, 3 to 5% Mo, 3 to 5% W, 35 to 40% Co, 10 to 30% Fe, 0.01 to 0.5% Al, 0.1 to 5% each of Si, Mn, and Ti.

In accordance with a sixth aspect of the invention, a material of the spring has a composition comprising by weight at least 0.05% or less C, 31 to 34% Ni, 19 to 21% Cr, 9 to 11% Mo, 35 to 40% Co, 10 to 30% Fe, 0.1 to 5% each of Si, Mn, Ti, and Nb.

In accordance with a seventh aspect of the invention, the weight has a spherical shape.

In accordance with an eighth aspect of the invention, the weight has its surface plated with a metal.

According to the above-described first aspect of the invention, the motion switch is comprised of a lead, a spring, a weight, a case, and a lower cover, and since the parts excluding the lower cover are simple in shape, the respective parts can be easily fabricated in compact sizes. Accordingly, it is possible to manufacture a motion switch in which the respective parts are compact and which is ultracompact as an overall configuration. In addition, since the lead is provided as the configuration of the motion switch, contact with a substrate on which the motion switch is mounted can be facilitated.

In addition, by virtue of the above-described structure, when the motion switch is stationary, the weight is resiliently pressed in a predetermined direction. Further, when a predetermined acceleration is applied to the motion switch in an opposite direction to the resiliently pressing direction, the weight moves from its predetermined position against the resilient force of the spring, and thereby changes the state of electrical contact with the lead to a state different from during the stationary state. As a result, the motion switch is able to detect the acceleration on the basis of the change in the state of electrical contact.

In addition, according to the above-described second aspect of the invention, the structure using two leads can facilitate connection to a substrate on which the motion switch is mounted.

Further, by virtue of the above-described structure, the motion switch is able to detect the acceleration on the basis of the change in the state of electrical connection between the two leads.

Furthermore, according to the above-described third aspect of the invention, the weight is resiliently pressed toward the innermost wall side of the case. By virtue of such a structure, when the motion switch is stationary, the weight is resiliently pressed toward the innermost wall side of the case. On the other hand, when a predetermined acceleration is applied to the motion switch in an opposite direction to the resiliently pressing direction, the weight moves toward the lower cover side against the resilient force of the spring and comes into electrical contact with the lead. As a result, the motion switch is able to detect the acceleration on the basis of the fact that the weight and the lead are electrically connected.

According to the above-described fourth aspect of the invention, as the material of the spring, an elastic material having properties in which a modulus of longitudinal elasticity is 206 to 225 gigapascals and a modulus of transverse elasticity is 80.4 to 83.3 gigapascals is used. As a result, as compared with a piano wire, stainless steel for a spring material, and beryllium copper or the like which are generally used as spring materials, the spring using the aforementioned material operates with high accuracy and is able to maintain predetermined resiliency for long periods of time.

According to the above-described fifth aspect of the invention, as compared with a piano wire, stainless steel for a spring material, and beryllium copper or the like which are generally used as spring materials, the spring has a small change in the modulus of elasticity due to the temperature. Therefore, even if the motion switch is used in locations of high-temperature environment such as in the vicinity of the engine or inside a tire, the spring operates with high accuracy. Additionally, since elastic fatigue is unlikely to occur with this spring, so that it is possible to prolong its service life.

According to the above-described sixth aspect of the invention, as compared with a piano wire, stainless steel for a spring material, and beryllium copper or the like which are generally used as spring materials, the spring has an even smaller change in the modulus of elasticity due to the temperature. Therefore, even if the motion switch is used in locations of high-temperature environment such as in the vicinity of the engine or inside a tire, the spring operates with higher accuracy. Additionally, since elastic fatigue is more unlikely to occur with this spring, so that it is possible to further prolong its service life.

According to the above-described seventh aspect of the invention, since the weight has a spherical shape, the fabrication is facilitated. In addition, since there is no limitation to the disposing direction, the assembly of the motion switch can be facilitated.

According to the above-described eighth aspect of the invention, the weight has its surface plated with a metal. Accordingly, it is possible to enlarge the degree of freedom in selecting the material of the weight body.

### BRIEF DESCRIPTION OF THE DRAWINGS

FIG. 1A is a perspective view of a motion switch in accordance with the invention;

FIG. 1B is a bottom view of the motion switch in accordance with the invention;

FIG. 2A is an enlarged view of the motion switch in accordance with the invention;

FIG. 2B is an enlarged view of the motion switch in accordance with the invention; and

FIG. 3 is a table illustrating respective temperature characteristics and durability of Example of the motion switch of the invention and Comparative Examples.

### DETAILED DESCRIPTION OF THE INVENTION

Referring now to the accompanying drawings, a description will be given of an embodiment of the invention.

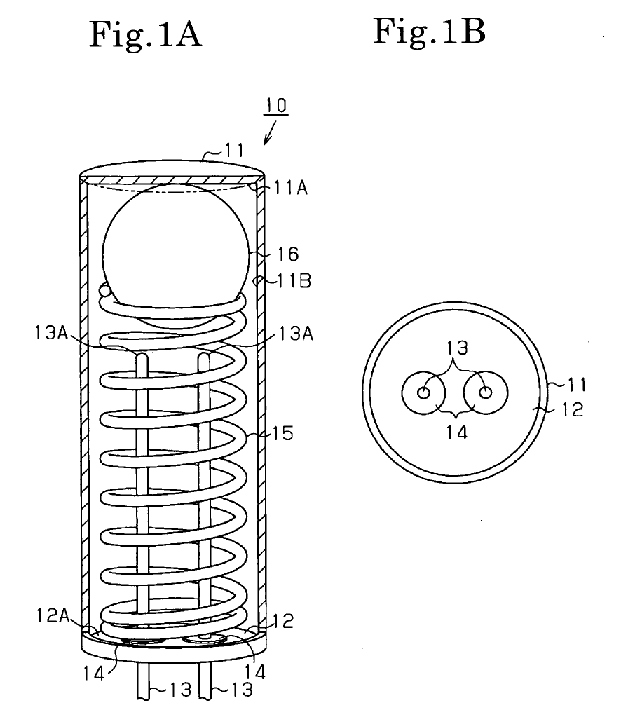

In FIGS. 1A and 1B, a motion switch 10 is a mechanical type ultracompact motion switch and has a bottomed cylindrical metallic case 11 and a lower cover 12. Two leads 13 are penetratingly provided in the lower cover 12, and a hermetic seal 14 for electrically insulating the lower cover 12 and each lead 13 is disposed between the lower cover 12 and each lead 13. Namely, each lead 13 is adapted to be supported by and fixed to the lower cover 12 through the hermetic seal 14. Further, the lower cover 12 is adapted to be pressed into and fixed to the metallic case 11 at its opening.

In addition, the two leads 13 respectively extend from the lower cover 12 in a direction toward an innermost wall 11A of the metallic case 11 up to a predetermined position spaced apart from the innermost wall 11A. Distal ends of the two leads serve as detection ends 13A which are each formed into a semispherical shape. A metallic ball 16 is disposed between the innermost wall 11A and the detecting ends 13A of the two leads 13 so as to be movable therebetween. The metallic ball 16 has its surface plated with a metal having small contact resistance, and when brought into contact with the detecting ends 13A of the two leads 13, the metallic ball 16 electrically connects the two leads 13.

A coil spring 15 is disposed in the metallic case 11 in such a manner as to surround the two leads 13. The coil spring 15 has a proximal end secured to an inner surface 12A of the lower cover 12 and a distal end abutting against the metallic ball 16 so as to space apart the metallic ball 16 from the detecting ends 13A of the leads 13 and impart to the metallic ball 16 a resilient force for resiliently pressing the metallic ball 16 against the inner wall 11A.

Accordingly, the metallic ball 16 is normally brought into pressure contact with the innermost wall 11A spaced apart from the detecting ends 13A of the two leads 13 so as to be not in electrical contact with the two leads 13. Meanwhile, when a force is applied to the metallic ball 16 in the direction toward the lower cover 12 (detecting ends 13A of the leads 13), the metallic ball 16 moves toward the side of the detecting ends 13A of the leads 13 against the resilient force of the coil spring 15. Then, when a force exceeding a predetermined magnitude is applied to the metallic ball 16, the metallic ball 16 is brought into contact with the detecting ends 13A of the leads 13 against the resilient force of the coil spring 15. Namely, the metallic ball 16 electrically connects the two leads 13.

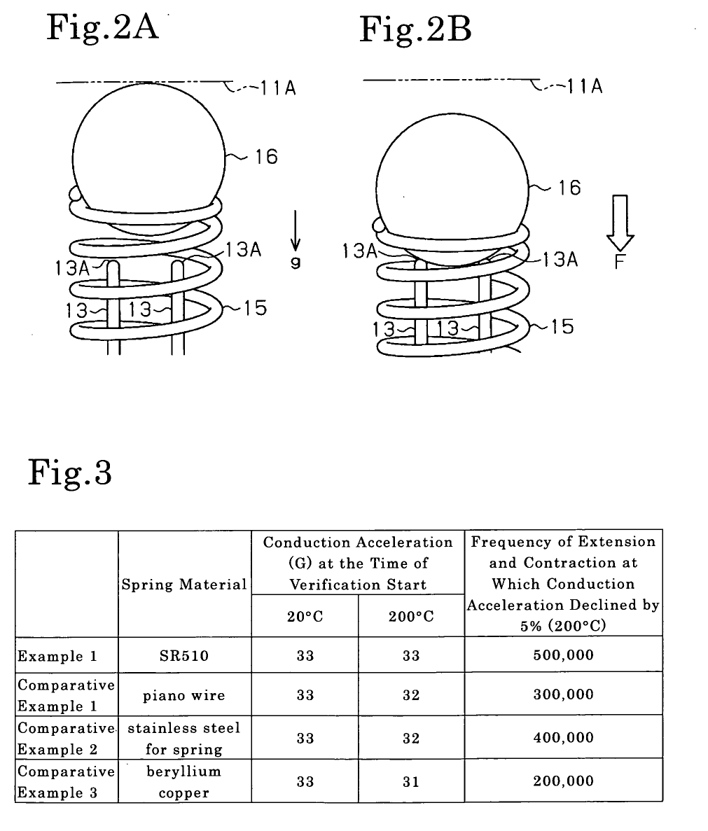

In other words, in a case where the motion switch 10 is stationarily placed with the metallic ball 16 located on the upper side, only the gravitational acceleration g is applied to the metallic ball 16, as shown in FIG. 2A, and the metallic ball 16 is held at a predetermined position on the innermost wall 11A side spaced apart from the detecting ends 13A by means of the coil spring 15. On the other hand, when a predetermined acceleration F is applied downward to the metallic ball 16, as shown in FIG. 2B, the metallic ball 16 presses and compresses the coil spring 15 toward its distal end, its surface is brought into contact with the respective detecting ends 13A, thereby allowing the two leads 13 to be electrically connected to each other.

More specifically, the metallic case 11 is made of albata (an alloy of copper, zinc, and nickel) and is formed with an outside diameter of 2 mm and a height of 4 mm. In addition, the lower cover 12 is made of kovar (an alloy of iron, nickel, and cobalt), is formed with a thickness of 0.3 mm and an outside diameter of 1.8 mm, and is adapted to hermetically close the interior of the metallic case 11 when the lower cover 12 is pressed fitted to the metallic case 11. Namely, as for the portion of the lower cover 12 where the lead 13 is passed through, the hermetic seal 14 is adapted to keep the insulation of the lead 13 and maintain sealability of the interior of the metallic case 11.

Each lead 13 is made of an alloy of iron and nickel and is formed with a wire diameter of φ 0.5 mm. Further, the coil spring 15 was made of SR510, a SPRON (trademark) material of SII Micro Parts Ltd. which is a highly elastic material, and its wire diameter φ was set to 0.1 mm. The metallic ball 16 has an outside diameter of 1.5 mm, and the surface thereof is subjected to gold plating for lowering the contact resistance. It should be noted that the SR510 is a Co-based alloy having a composition (by weight) of 0.03% C, 0.1% Si, 0.5% Mn, 0.02% P, 0.02% S, 31.4 to 33.4% Ni, 19.5 to 20.5% Cr, 9.5 to 10.5% Mo, 0.8 to 1.2% Nb, 0.3 to 0.7% Ti, 1.10 to 2.10% Fe, and a balance of Co and a trace amount of unavoidable impurities. The SR510 as an elastic material has a modulus of longitudinal elasticity of 216 to 225 gigapascals (22 to 23×1000 kilograms per square millimeter) and a modulus of transverse elasticity of 83.3 gigapascals (8.5×1000 kilograms per square millimeter)

To begin with, since the above-described structure is adopted as the structure of the motion switch 10, the parts excluding the lower cover 12 are simple in shape, so that the respective parts can be easily fabricated in compact sizes. It should be noted that although the lower cover 12 was complex as compared with the other parts, since a technology adopted in crystal oscillators of a hollow cylindrical shape was used, it was possible to fabricate an ultracompact part, such as the one described above, by making use of the parts technology of the crystal oscillators. In addition, since the overall configuration was similar to those of crystal oscillators in which an ultracompact type is already present, it was possible to easily fabricate the above-described ultracompact motion switch 10 with an outside diameter of 2 mm and a height of 4 mm by making use of the manufacturing technology of the crystal oscillators.

Next, since the structure adopted is such that the two leads 13 are led out from the lower cover 12, after the leads 13 of the motion switch 10 are inserted through a substrate by an automatic mounter or the like, the leads 13 are soldered by a reflow soldering device or the like, thereby facilitating the assembly. In addition, since the structure in which the two leads 13 are led out from the lower cover 12 is the same as the structure of the hollow cylindrical crystal oscillator, the manufacturing technology of the crystal oscillators can be made use of, so that it is unnecessary to design new manufacturing equipment.

Finally, since the SPRON material, such as SR100 or SR510, which is the so-called highly elastic material, is used as the material of the aforementioned coil spring 15, it is possible to reduce a change in the modulus of elasticity due to the temperature as compared with a piano wire, stainless steel for a spring material, and beryllium copper or the like which are generally used as spring materials. For this reason, it is possible to provide the motion switch 10 which, even if used in a high-temperature environment such as in the vicinity of the engine or inside a tire, can operate with high accuracy and in which elastic fatigue is unlikely to occur, and which can withstand long periods of use even in severe environments. It should be noted that the SR100 is a Co-based alloy having a composition (by weight) of 0.03% C, 0.8 to 1.05% Si, 0.5 to 1.10% Mn, 0.02% P, 0.02% S, 16.0 to 17.0% Ni, 11.6 to 12.2% Cr, 3.80 to 4.20% Mo, 3.85 to 4.15% W, 38.0 to 39.4% Co, 0.4 to 0.8% Ti, 0.04 to 0.12% Al, and a balance of Fe and a trace amount of unavoidable impurities. The SR100 as an elastic material has a modulus of longitudinal elasticity of 206 to 216 gigapascals (21 to 22×1000 kilograms per square millimeter) and a modulus of transverse elasticity of 80.4 gigapascals (8.2×1000 kilograms per square millimeter).

Incidentally, verification was made by carrying out examples in which the material of the spring material was varied.

### EXAMPLE 1

In the motion switch 10 shown in FIGS. 1A and 1B, the metallic case 11 was formed into an outside diameter of 2 mm and a height of 4 mm by press working albata having a thickness of 0.1 mm. As for the lower cover 12, an outer periphery having an outside diameter of 1.8 mm and two holes for leading out the leads were simultaneously punched out of a 0.3 mm thick kovar plate by a press. The leads 13 made of an alloy of iron and nickel, having a wire diameter of φ 0.5 mm, and cut to a predetermined length were respectively inserted in the holes and were joined to the lower cover 12 by the hermetic seal 14 made of glass. The coil spring 15 was fabricated by subjecting a wire material made of SR510 and having a wire diameter of φ 0.1 mm to wire winding so that the coil spring 15 assumes such a modulus of elasticity that the below-described metallic ball 16 contacts the detecting ends 13A of the leads 13 with a stress (in a direction perpendicular to the coil spring 15) of 33 G (G represents a gravitational acceleration (9.8 m/(s×s)). Generally, the adjustment of the modulus of elasticity of the helical (coil) spring in comparison with a leaf spring or the like is easy and has a large degree of freedom. As for the metallic ball 16, after steel was processed into a ball with an outside diameter of 1.5 mm, its surface was provided with gold plating so as to reduce the contact resistance. Using these parts, the lower cover 12 was press fitted to the metallic case 11 to thereby fabricate the motion switch 10, as shown in FIGS. 1A and 1B.

### COMPARATIVE EXAMPLE 1

In Comparative Example 1, although a configuration similar to that of Example 1 was adopted, a piano wire was used as the material of the coil spring 15.

### COMPARATIVE EXAMPLE 2

In Comparative Example 2, although a configuration similar to that of Example 1 was adopted, stainless steel for a spring material was used as the material of the coil spring 15.

### COMPARATIVE EXAMPLE 3

In Comparative Example 3, although a configuration similar to that of Example 1 was adopted, beryllium copper was used as the material of the coil spring 15.

Then, five pieces were respectively fabricated as the motion switches of Example 1 and Comparative Examples 1 to 3 mentioned above, and the following verification was made.

First, to confirm variations due to changes in the environmental temperature concerning the value of the gravitational acceleration for allowing the two leads of the motion switch to conduct with each other, values of the gravitational acceleration for allowing the two leads of the motion switch to conduct with each other were confirmed in a normal temperature environment and a high-temperature environment.

Specifically, examinations were made of respective values of the gravitational acceleration (these values will be referred to as the conduction acceleration) in cases where the two leads of these four kinds of motion switches 10 conducted with each other, i.e., in cases where the metallic ball 16 contacted the detecting ends 13A of the two leads 13, in environments at 20 degrees Celsius and 200 degrees Celsius. The results are shown in Table 20 of FIG. 3.

In addition, to confirm the durability of the motion switch in the high-temperature environment, confirmation was made of changes based on the frequency of the mutual conduction of the two leads, i.e., the frequency of extension and contraction of the spring, concerning the gravitational acceleration for allowing the two leads of the motion switch to conduct with each other in the high-temperature environment. Specifically, Table 20 shows the results of investigation of the frequency of extension and contraction of the spring at which the value of the conduction acceleration at the time of the verification start declined by 5% or more on the average in the environment of 200 degrees Celsius.

(1) First, as shown in Table 20, it can be seen that the conduction accelerations at 20 degrees Celsius and 200 degrees Celsius in Example 1 are fixed in comparison with Comparative Examples 1 to 3. This is because, in Example 1, SR510 which is a highly elastic material was used as the material of the coil spring 15, and the elasticity of the SR510 did not substantially change up to 200 degrees Celsius or thereabouts.

(2) Next, as shown in Table 20, the frequency of extension and contraction at which the conduction acceleration at 200 degrees Celsius declined by 5% or more was largest in Example 1 as compared with Comparative Examples 1 to 3. This is because SR510 was used as the material of the coil spring 15, and metal fatigue due to the stress was unlikely to accumulate in the SR510.

Next, a description will be given below of the effects of this embodiment configured as described above.

(1) According to this embodiment, as the structure of the motion switch 10, the two metallic leads 13 are provided as connection to a substrate, and the coil spring 15 is disposed between the cylindrical metallic case 11 and the two leads 13 in such a manner as to surround the two leads 13. In addition, the metallic ball 16 whose surface is plated with a metal having a low contact resistance is disposed on that coil spring 15 between each detecting end 13A and the innermost wall 11A so as not to contact the respective detecting ends 13A of the two leads. The metallic lower cover 12 is disposed on the lower side of the cylindrical metallic case 11. Since the structure adopted is such that two leads 13 are supported in that metallic lower cover 12 in a state of being each electrically insulated by the hermetic seal 14 and the like, and the lower cover 12 is press fitted in the metallic case 11, it is possible to fabricate the motion switch 10 which excels in productivity, is ultracompact, and facilitates connection to the substrate.

(2) According to this embodiment, since the SPRON material, such as SR100 or SR510, which is the so-called highly elastic material, is used as the material of the aforementioned coil spring 15, it is possible to provide the motion switch 10 which, even if used in a high-temperature environment such as in the vicinity of the engine or inside a tire, can operate with high accuracy and can withstand long periods of use.

### Other Embodiments

It should be noted that the above-described embodiment can be carried out in the following embodiments, for example. In the above-described embodiment, the metallic ball 16 is brought into contact with the detecting ends 13A. However, the invention is not limited to the same, and a member which comes into contact with the detecting ends 13A of the leads 13 may have any shape insofar as it is capable of being disposed in the metallic case 11.

In the above-described embodiment, the lengths of the leads 13 inside the metallic case 11 are respectively the same, but are not limited to the same length.

In the above-described embodiment, the metallic ball 16 is resiliently pressed toward the innermost wall 11A by the coil spring 15. However, the invention is not limited to the same, and an arrangement may be provided such that the coil spring 15 is disposed between the metallic ball 16 and the innermost wall 11A to normally bring the metallic ball 16 into contact with the detecting ends 13A, such that when a predetermined acceleration is applied to the metallic ball 16 in an opposite direction to the resiliently pressing direction of the coil spring 15, the metallic ball 16 is spaced apart from the detecting ends 13A. By so doing, it is possible to shorten the length of each lead 13. Additionally, it is possible to easily detect faulty contact between the metallic ball 16 and the detecting ends 13A.

Although in the above-described embodiment the number of the leads 13 is two, the number of the leads 13 is not limited to the same. In a case where the number of the leads 13 is one, acceleration can be detected by mutual conduction between the lead 13 and a side wall 11B or between the lead 13 and the coil spring 15. Also, in a case where the number of the leads 13 is three or more, it is possible to increase the stability of the metallic ball 16 in contact with the respective detecting ends 13A.

What is claimed is:

1. A motion switch comprising:
a bottomed cylindrical metallic case;
a lower cover for sealing an opening of the case;
a metallic lead penetrating the lower cover and fixed therein;
an electrically conductive weight disposed in a hermetically sealed space of the case sealed by the lower cover in such a manner as to be movable between an innermost wall of the case and a distal end portion of the lead; and
a spring for resiliently pressing the weight disposed in the hermetically sealed space in a predetermined direction toward one of the innermost wall of the case and the distal end portion of the lead.

2. The motion switch according to claim 1, wherein two leads are provided as the lead in such a manner as to penetrate the lower cover and to be fixed therein.

3. The motion switch according to claim 1, wherein the lower cover comprises a metallic ring fitted to the case and a glass filled in the metallic ring, and the spring is wound around an outer side of the lead projecting into the hermetically sealed space so as to resiliently press the weight toward a side of the innermost wall of the case.

4. The motion switch according to claim 2, wherein the lower cover comprises a metallic ring fitted to the case and a glass filled in the metallic ring, and the spring is wound around an outer side of the lead projecting into the hermetically sealed space so as to resiliently press the weight toward a side of the innermost wall of the case.

5. The motion switch according to claim 1, wherein a material of the spring is an elastic material having properties in which a modulus of longitudinal elasticity is 206 to 225 gigapascals and a modulus of transverse elasticity is 80.4 to 83.3 gigapascals.

6. The motion switch according to claim 1, wherein a material of the spring has a composition comprising by weight at least 0.05% or less C, 15 to 18% Ni, 10 to 14% Cr, 3 to 5% Mo, 3 to 5% W, 35 to 40% Co, 10 to 30% Fe, 0.01 to 0.5% Al, 0.1 to 5% each of Si, Mn, and Ti.

7. The motion switch according to claim 2, wherein a material of the spring has a composition comprising by weight at least 0.05% or less C, 15 to 18% Ni, 10 to 14% Cr, 3 to 5% Mo, 3 to 5% W, 35 to 40% Co, 10 to 30% Fe, 0.01 to 0.5% Al, 0.1 to 5% each of Si, Mn, and Ti.

8. The motion switch according to claim 3, wherein a material of the spring has a composition comprising by weight at least 0.05% or less C, 15 to 18% Ni, 10 to 14% Cr, 3 to 5% Mo, 3 to 5% W, 35 to 40% Co, 10 to 30% Fe, 0.01 to 0.5% Al, 0.1 to 5% each of Si, Mn, and Ti.

9. The motion switch according to claim 1, wherein a material of the spring has a composition comprising by weight at least 0.05% or less C, 31 to 34% Ni, 19 to 21% Cr, 9 to 11% Mo, 35 to 40% Co, 10 to 30% Fe, 0.1 to 5% each of Si, Mn, Ti, and Nb.

10. The motion switch according to claim 2, wherein a material of the spring has a composition comprising by weight at least 0.05% or less C, 31 to 34% Ni, 19 to 21% Cr, 9 to 11% Mo, 35 to 40% Co, 10 to 30% Fe, 0.1 to 5% each of Si, Mn, Ti, and Nb.

11. The motion switch according to claim 3, wherein a material of the spring has a composition comprising by weight at least 0.05% or less C, 31 to 34% Ni, 19 to 21% Cr, 9 to 11% Mo, 35 to 40% Co, 10 to 30% Fe, 0.1 to 5% each of Si, Mn, Ti, and Nb.

12. The motion switch according to claim 1, wherein the weight has a spherical shape.

13. The motion switch according to claim 1, wherein the weight has its surface plated with a metal.
